(19) United States
(12) Patent Application Publication
(10) Pub. No.: US 2024/0041122 A1
(43) Pub. Date: Feb. 8, 2024

(54) AEROSOL PROVISION DEVICE

(71) Applicant: NICOVENTURES TRADING LIMITED, London (GB)

(72) Inventors: Anton KORUS, Derbyshire (GB); Patrick MOLONEY, London (GB)

(21) Appl. No.: 18/263,922

(22) PCT Filed: Feb. 10, 2022
(86) PCT No.: PCT/EP2022/053291

§ 371 Date: Aug. 2, 2023

(30) Foreign Application Priority Data
Feb. 10, 2021 (GB) 2101855.1

(51) Int. Cl. A24F 40/465; H05B 6/10; H05B 6/12; A24F 40/20; A24D 1/20

(52) U.S. Cl. CPC A24F 40/465; H05B 6/105; H05B 6/1272; A24F 40/20; A24D 1/20

(57) ABSTRACT

An aerosol provision device is disclosed and can include an aerosol generator including one or more heating zones for receiving at least a portion of an article including aerosol generating material, a magnetic field generator configured to generate a time varying magnetic field and an AC voltage supply configured to supply an AC voltage to the magnetic field generator at a frequency f1, wherein f1<500 kHz.

### PRIORITY CLAIM

The present application is a National Phase entry of PCT Application No. PCT/EP2022/053291, filed Feb. 10, 2022, which claims priority from GB Application No. 2101855.1, filed Feb. 10, 2021, each of which is hereby fully incorporated herein by reference.

### TECHNICAL FIELD

The present disclosure relates to an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

One problem with conventional arrangements is that they can suffer from switching losses.

Another problem with conventional arrangements is that they use relatively high frequencies for the induction heating system. Multi-strand wire configured for use at these higher frequencies is relatively expensive. In addition to the cost, the relative expense means that commercially the inductive heating system cannot be incorporated into a consumable.

It is desired to provide an improved aerosol provision device.

### SUMMARY

According to an aspect there is provided an aerosol provision device comprising: an aerosol generator comprising one or more heating zones for receiving at least a portion of an article comprising aerosol generating material; a magnetic field generator configured to generate a time varying magnetic field; and an AC voltage supply configured to supply an AC voltage to the magnetic field generator at a frequency f1, wherein f1<500 kHz.

The aerosol provision device according to various embodiments may have reduced switching losses compared with conventional arrangements. Furthermore, by operating in an AC frequency regime of <500 kHz the magnetic field generator which may comprise an induction coil comprising multi-strand wire can be manufactured at a lower cost compared to conventional induction coils. Indeed, it is contemplated that the cost may be reduced to such an extent that the induction coil comprising multi-strand wire may be incorporated into an article comprising aerosol generating material or provided as part of another consumable.

Optionally, the magnetic field generator comprises one or more inductor coils.

Optionally, the one or more inductor coils comprise one or more multi-strand wires, such as LITZ (RTM) wires.

Optionally, the one or more multi-strand wires may comprise a plurality of strands, wherein each strand has a thickness less than the skin depth of the strand at frequency f1.

Optionally, the aerosol provision device further comprises one or more susceptors.

Optionally, the magnetic field generator is configured to induce heating in the one or more susceptors.

Optionally, the one or more susceptors comprise: (i) nickel; (ii) steel; (iii) a body having a nickel coating optionally wherein the nickel coating has a thickness <5 μm; (iv) a sheet of mild steel optionally wherein the sheet of mild steel has a thickness <50 μm; or (v) an aluminum foil.

Optionally, the frequency f1 is selected from the group comprising: (i) <50 kHz; (ii) 50-100 kHz; (iii) 100-150 kHz; (iv) 150-200 kHz; (v) 200-250 kHz; (vi) 250-300 kHz; (vii) 300-350 kHz; (viii) 350-400 kHz; (ix) 400-450 kHz; and (x) 450-500 kHz.

According to another aspect there is provided an aerosol provision system comprising: an aerosol provision device as described above; and an article comprising aerosol generating material.

Optionally, the article further comprises one or more susceptors.

Optionally, the one or more susceptors comprise: (i) nickel; (ii) steel; (iii) a body having a nickel coating optionally wherein the nickel coating has a thickness <5 μm; (iv) a sheet of mild steel optionally wherein the sheet of mild steel has a thickness <50 μm; or (v) an aluminum foil.

Optionally, the article further comprises one or more inductor coils.

Optionally, the one or more inductor coils comprise one or more multi-strand wires.

Optionally, the one or more multi-strand wires comprise a plurality of strands, wherein each strand has a thickness less than the skin depth of the strand at frequency f1.

According to another aspect there is provided an aerosol provision system comprising: an aerosol provision device comprising an aerosol generator comprising one or more heating zones for receiving at least a portion of an article comprising aerosol generating material; and an article comprising aerosol generating material, wherein the article further comprises a magnetic field generator; wherein the aerosol provision device further comprises an AC voltage supply configured to supply an AC voltage to the magnetic field generator at a frequency f1, wherein f1<500 kHz.

Optionally, the magnetic field generator comprises one or more inductor coils.

Optionally, the one or more inductor coils comprise one or more multi-strand wires.

Optionally, the one or more multi-strand wires comprise a plurality of strands, wherein each strand has a thickness less than the skin depth of the strand at frequency f1.

Optionally, the aerosol provision device further comprises one or more susceptors.

Optionally, the article further comprises one or more susceptors.

Optionally, the magnetic field generator is configured to induce heating in the one or more susceptors.

Optionally, the one or more susceptors comprise: (i) nickel; (ii) steel; (iii) a body having a nickel coating optionally wherein the nickel coating has a thickness <5 μm; (iv) a sheet of mild steel optionally wherein the sheet of mild steel has a thickness <50 μm; or (v) an aluminum foil.

Optionally, the frequency f1 is selected from the group comprising: (i) <50 kHz; (ii) 50-100 kHz; (iii) 100-150 kHz; (iv) 150-200 kHz; (v) 200-250 kHz; (vi) 250-300 kHz; (vii) 300-350 kHz; (viii) 350-400 kHz; (ix) 400-450 kHz; and (x) 450-500 kHz.

According to another aspect there is provided a method of generating an aerosol comprising: providing one or more heating zones for receiving at least a portion of an article comprising aerosol generating material; generating a time varying magnetic field using a magnetic field generator; and supplying an AC voltage to the magnetic field generator at a frequency f1, wherein f1<500 kHz.

### BRIEF DESCRIPTION OF THE DRAWINGS

Various embodiments will now be described, by way of example only, and with reference to the accompanying drawings, in which:

FIG. 1 shows a schematic side view of an example of an aerosol provision system.

FIG. 2 is a flow diagram showing an example of a method of heating aerosol generating material.

FIG. 3 is a flow diagram showing another example of a method of heating aerosol generating material.

FIG. 4 shows a schematic cross-sectional side view of an inductor arrangement of an aerosol provision device of the system of FIG. 1.

FIG. 5 shows a schematic perspective view of an inductor of the inductor arrangement of FIG. 4.

FIG. 6A shows a side view of multi-strand wire wherein some strands are shown exposed and FIG. 6B shows a cross-section view of a multi-strand wire.

FIG. 7A shows a plan view of a planar aerosol generating article, FIG. 7B shows an end-on view of the aerosol generating article and shows a plurality of susceptors embedded into the aerosol generating article and FIG. 7C shows a side view of the aerosol generating article and shows a plurality of susceptors embedded into the aerosol generating article.

### DETAILED DESCRIPTION OF THE DRAWINGS

As used herein, the term “aerosolizable material”, also referred to as aerosol generating material, includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, a solid, gelled sheet, powder, beads, granules, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

In one example, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object.

Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

The alternating currents used to produce such varying magnetic fields currents are affected by the so called “skin effect” at high frequencies. Such alternating currents in a conductor carried predominantly at the surface of the material, with the current density decreasing exponentially with distance from the surface. This is described by the well-known “skin depth” formula:

δ=\sqrt{ρ/πμf}

where δ is the depth at which the current density has decreased to 1/e (approximately 37%) of the value at the surface, ρ is the resistivity of the conductor and μ is the magnetic permeability of the conductor.

This reduction in current carrying area of the wire increases the effective resistance of the wire, leading to increased energy loss (known as “AC loss”). This may lead to reduced efficiency of a varying magnetic field generator. As the skin depth decreases with frequency, this energy loss increases as frequency is increased.

In an inductive heating system, a similar effect occurs in the susceptor, where the induced current density decreases with distance from the surface of the susceptor. Accordingly, reducing the skin depth of the susceptor by using high frequency magnetic fields can lead to increased current in the surface regions of the susceptor, leading to faster and more efficient heating.

According to various embodiments, the frequency of the magnetic field generator f1 may be less than 500 kHz. Whilst this may lead to reduced efficiency in heating the susceptor, the Applicants have identified various benefits to operating at lower frequencies. In particular, as discussed above, at lower frequencies the skin depth in the induction coils is reduced, and therefore AC losses in the inductor are reduced.

The inductor may comprise multi-strand wire, such as LITZ (RTM) wire. In such a wire, current is carried across multiple strands, each of which is insulated from one the others. Each strand may be thinner than a skin depth of the conductor, reducing AC losses due to the skin effect.

Using frequencies below 500 kHz is particularly beneficial when using multi-strand wire. By operating at a lower frequency, the strand thickness of the multi-strand wire may be increased and the strand count reduced. Accordingly, the multi-strand wire may be manufactured at reduced cost and may have improved mechanical properties compared to multi-strand wire configured for higher frequency operation.

According to an arrangement, an aerosol provision device is disclosed comprising one or more heating zones for receiving at least a portion of an article comprising aerosol generating material, a magnetic field generator configured to generate a time varying magnetic field and an voltage supply configured to supply an AC voltage to the magnetic field generator at a frequency f1, wherein f1<500 kHz. According to various embodiments the frequency f1 may be selected from the group comprising: (i) <50 kHz; (ii) 50-100 kHz; (iii) 100-150 kHz; (iv) 150-200 kHz; (v) 200-250 kHz; (vi) 250-300 kHz; (vii) 300-350 kHz; (viii) 350-400 kHz; (ix) 400-450 kHz; and (x) 450-500 kHz.

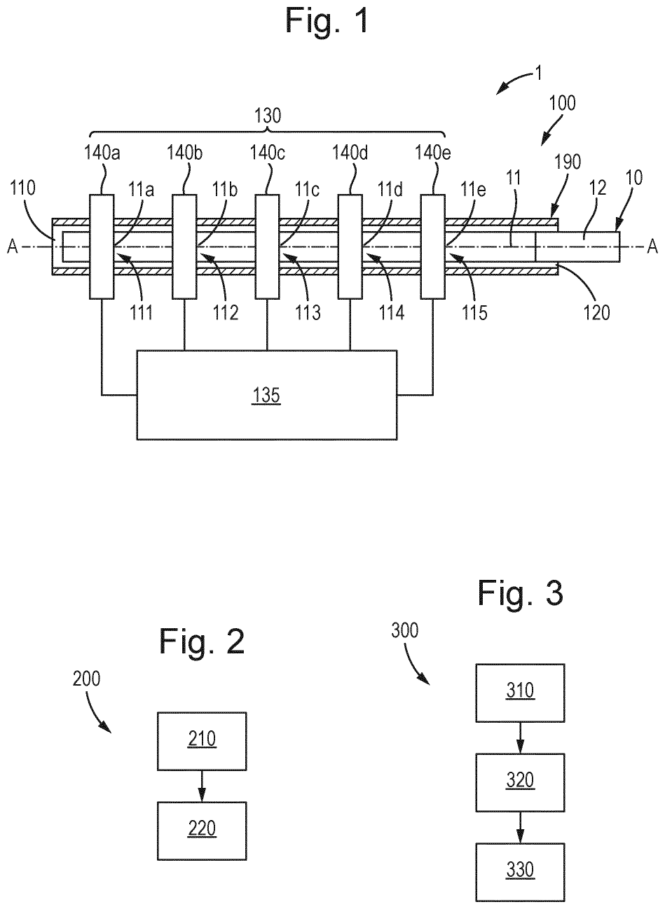

Referring to FIG. 1, there is shown a schematic cross-sectional side view of an example of an aerosol provision system 1. The system 1 comprises an aerosol provision device 100 and an article 10 comprising aerosol generating material 11. The aerosol generating material 11 may, for example, be of any of the types of aerosol generating material discussed herein. In this example, the aerosol provision device 100 is a tobacco heating product (also known in the art as a tobacco heating device or a heat-not-burn device).

In some examples, the aerosol generating material 11 is a non-liquid material. In some examples, the aerosol generating material 11 is a gel. In some examples, the aerosol generating material 11 comprises tobacco. However, in other examples, the aerosol generating material 11 may consist of tobacco, may consist substantially entirely of tobacco, may comprise tobacco and aerosol generating material other than tobacco, may comprise aerosol generating material other than tobacco, or may be free from tobacco. In some examples, the aerosol generating material 11 may comprise a vapor or aerosol forming agent or a humectant, such as glycerol, propylene glycol, triacetin, or diethylene glycol. In some examples, the aerosol generating material 11 comprises reconstituted aerosol generating material, such as reconstituted tobacco.

In some examples, the aerosol generating material 11 is substantially cylindrical with a substantially circular cross section and a longitudinal axis. In other examples, the aerosol generating material 11 may have a different cross-sectional shape and/or not be elongate.

The aerosol generating material 11 of the article 10 may, for example, have an axial length of between 8 mm and 120 mm. For example, the axial length of the aerosol generating material 11 may be greater than 9 mm, or 10 mm, or 15 mm, or 20 mm. For example, the axial length of the aerosol generating material 11 may be less than 100 mm, or 75 mm, or 50 mm, or 40 mm.

In some examples, such as that shown in FIG. 1, the article 10 comprises a filter arrangement 12 for filtering aerosol or vapor released from the aerosol generating material 11 in use. Alternatively, or additionally, the filter arrangement 12 may be for controlling the pressure drop over a length of the article 10. The filter arrangement 12 may comprise one, or more than one, filter. The filter arrangement 12 could be of any type used in the tobacco industry. For example, the filter may be made of cellulose acetate. In some examples, the filter arrangement 12 is substantially cylindrical with a substantially circular cross section and a longitudinal axis. In other examples, the filter arrangement 12 may have a different cross-sectional shape and/or not be elongate.

In some examples, the filter arrangement 12 abuts a longitudinal end of the aerosol generating material 11. In other examples, the filter arrangement 12 may be spaced from the aerosol generating material 11, such as by a gap and/or by one or more further components of the article 10. In some examples, the filter arrangement 12 may comprise an additive or flavor source (such as an additive- or flavor-containing capsule or thread), which may be held by a body of filtration material or between two bodies of filtration material, for example.

The article 10 may also comprise a wrapper (not shown) that is wrapped around the aerosol generating material 11 and the filter arrangement 12 to retain the filter arrangement 12 relative to the aerosol generating material 11. The wrapper may be wrapped around the aerosol generating material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosol generating material (e.g. reconstituted tobacco). The paper may be a tipping paper that is known in the art. The wrapper may also comprise an adhesive (not shown) that adheres overlapped free ends of the wrapper to each other, to help prevent the overlapped free ends from separating. In other examples, the adhesive may be omitted or the wrapper may take a different from to that described. In other examples, the filter arrangement 12 may be retained relative to the aerosol generating material 11 by a connector other than a wrapper, such as an adhesive. In some examples, the filter arrangement 12 may be omitted.

The aerosol provision device 100 comprises a heating zone 110 for receiving at least a portion of the article 10, an outlet 120 through which aerosol is deliverable from the heating zone 110 to a user in use, and heating apparatus 130 for causing heating of the article 10 when the article 10 is at least partially located within the heating zone 110 to thereby generate the aerosol. In some examples, such as that shown in FIG. 1, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

The aerosol provision device 100 may define at least one air inlet (not shown) that fluidly connects the heating zone 110 with an exterior of the aerosol provision device 100. A user may be able to inhale the volatilized component(s) of the aerosol generating material by drawing the volatilized component(s) from the heating zone 110 via the article 10. As the volatilized component(s) are removed from the heating zone 110 and the article 10, air may be drawn into the heating zone 110 via the air inlet(s) of the aerosol provision device 100.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the aerosol provision device 100 may include a mouthpiece that can be arranged to cover the outlet 120 and through which the aerosol can be drawn from the heating zone 110 and the article 10.

In this example, when the article 10 is at least partially located within the heating zone 110, different portions 11a-11e of the aerosol generating material 11 are located at different respective locations 111-115 in the heating zone 110. In this example, these locations 111-115 are at different respective axial positions along the axis A-A of the heating zone 110. Moreover, in this example, since the heating zone 110 is elongate, the locations 111-115 can be considered to be at different longitudinally-spaced-apart positions along the length of the heating zone 110. In this example, the article 10 can be considered to comprise five such portions 11a-11e of the aerosol generating material 11 that are located respectively at a first location 111, a second location 112, a third location 113, a fourth location 114 and a fifth location 115. More specifically, the second location 112 is fluidly located between the first location 111 and the outlet 120, the third location 113 is fluidly located between the second location 112 and the outlet 120, the fourth location 114 is fluidly located between the third location 113 and the outlet 120, and the fifth location 115 is fluidly located between the fourth location 114 and the outlet 120.

The heating apparatus 130 comprises plural heating units 140a-140e, each of which is able to cause heating of a respective one of the portions 11a-11e of the aerosol generating material 11 to a temperature sufficient to aerosolize a component thereof, when the article 10 is at least partially located within the heating zone 110. The plural heating units 140a-140e may be axially-aligned with each other along the axis A-A. Each of the portions 11a-11e of the aerosol generating material 11 heatable in this way may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

The heating apparatus 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone 110. More specifically, the second heating unit 140b is located between the first heating unit 140a and the outlet 120, the third heating unit 140c is located between the second heating unit 140b and the outlet 120, the fourth heating unit 140d is located between the third heating unit 140c and the outlet 120, and the fifth heating unit 140e is located between the fourth heating unit 140d and the outlet 120. In other examples, the heating apparatus 130 could comprise more than five heating units 140a-140e or fewer than five heating units, such as only four, only three, only two, or only one heating unit. The number of portion(s) of the aerosol generating material 11 that are heatable by the respective heating unit(s) may be correspondingly varied.

The heating apparatus 130 also comprises a controller 135 that is configured to cause operation of the heating units 140a-140e to cause the heating of the respective portions 11a-11e of the aerosol generating material 11 in use. In this example, the controller 135 is configured to cause operation of the heating units 140a-140e independently of each other, so that the respective portions 11a-11e of the aerosol generating material 11 can be heated independently. This may be desirable in order to provide progressive heating of the aerosol generating material 11 in use. Moreover, in examples in which the portions 11a-11e of the aerosol generating material 11 have different respective forms or characteristics, such as different tobacco blends and/or different applied or inherent flavors, the ability to independently heat the portions 11a-11e of the aerosol generating material 11 can enable heating of selected portions 11a-11e of the aerosol generating material 11 at different times during a session of use so as to generate aerosol that has predetermined characteristics that are time-dependent. In some examples, the heating apparatus 130 may nevertheless also be operable in one or more modes in which the controller 135 is configured to cause operation of more than one of the heating units 140a-140e, such as all of the heating units 140a-140e, at the same time during a session of use.

In this example, the heating units 140a-140e comprise respective induction heating units that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors 150 of the respective heating units 140a-140e. Moreover, in this example, the aerosol provision device 100 comprises a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosol generating material 11 at the respective locations 111-115 in the heating zone 110.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 11a-11e of the aerosol generating material 11. Each of the plural susceptors may be tubular or take one of the other forms discussed herein for the susceptor 190, for example. In still further examples, the aerosol provision device 100 may be free from the susceptor 190, and the article 10 may comprise one or more susceptors that are heatable by penetration with the varying magnetic fields to thereby cause heating of the respective portions 11a-11e of the aerosol generating material 11. Each of the one or more susceptors of the article 10 may take any suitable form, such as a structure (e.g. a metallic foil, such as an aluminum foil) wrapped around or otherwise encircling the aerosol generating material 11, a structure located within the aerosol generating material 11, or a group of particles or other elements mixed with the aerosol generating material 11. In examples in which the aerosol provision device 100 is free from the susceptor 190, the susceptor 190 may be replaced by a heat-resistant tube that partially delimits the heating zone 110. Such a heat-resistant tube may, for example, be made from polyether ether ketone (PEEK) or a ceramic material.

In this example, the heating apparatus 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 comprises an integrated circuit (IC), such as an IC on a printed circuit board (PCB). In other examples, the controller 135 may take a different form.

The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

In this example, operation of the user interface by a user causes the controller 135 to cause an alternating electrical current to pass through the inductor 150 of at least one of the respective heating units 140a-140e. This causes the inductor 150 to generate an alternating magnetic field. The inductor 150 and the susceptor 190 are suitably relatively positioned so that the varying magnetic field produced by the inductor 150 penetrates the susceptor 190. When the susceptor 190 is electrically-conductive, this penetration causes the generation of one or more eddy currents in the susceptor 190. The flow of eddy currents in the susceptor 190 against the electrical resistance of the susceptor 190 causes the susceptor 190 to be heated by Joule heating. When the susceptor 190 is magnetic, the orientation of magnetic dipoles in the susceptor 190 changes with the changing applied magnetic field, which causes heat to be generated in the susceptor 190.

The aerosol provision device 100 may also comprise a secondary coil (not shown) which may act as a sensing coil for sensing an induced varying electrical current through the secondary coil, induced when the electrical power source applies a varying electrical current to the inductor 150 of at least one of the respective heating units 140a-140e as controlled by the controller 135. Each inductor 150 of the respective heating units 140a-140e may have a respective secondary coil.

In this example, when the controller 135 passes a varying electrical current through the inductor 150 of at least one of the respective heating unit's 140a-140e, the inductor 150 generates an alternating magnetic field. The alternating magnetic field generates eddy currents in the respective secondary coil, thereby inducing a varying electrical current in the secondary coil. The secondary coil may be positioned above or below the inductor 150, for example in a plane parallel to the inductor 150.

In other examples where there may be more than one inductor 150, the secondary coil may be placed between the inductors 150 such that both inductors 150 induce a varying electrical current through the secondary coil. However, in other examples where each of the heating units 140a-140e comprise more than one respective inductor 150, there may be a respective secondary coil for each respective inductor 150, so that each respective inductor 150 induces a varying electrical current into the respective secondary coil.

The current induced across the secondary coil produces a corresponding voltage across the secondary coil which can be measured by the controller 135 and is proportional to the current flowing to the inductor 150. This means the voltage across the secondary coil may be recorded by the controller 135 as a function of a drive frequency of the device. The controller 135 on the basis of this measurement may calculate the temperature of the heating chamber 110, the susceptor 190 or the article 10, respectively. The controller 135 may then cause a characteristic of the varying or alternating electrical current being applied to the inductor 150 of the at least one heating units 140a-140e, to be adjusted as necessary, in order to ensure that the temperature of the heating chamber 110, the susceptor 190 or the article 10, respectively, remains within a predetermined temperature range. The characteristic may be, for example, amplitude or frequency or duty cycle.

In some examples the secondary coil may be a coil of wire, or a track on a PCB. In some examples the secondary coil may comprise any one or more of nickel, steel, iron and cobalt.

The aerosol provision device 100 may comprise a temperature sensor (not shown) for sensing a temperature of the heating chamber 110, the susceptor 190 or the article 10. The temperature sensor may be communicatively connected to the controller 135, so that the controller 135 is able to monitor the temperature of the heating chamber 110, the susceptor 190 or the article respectively, on the basis of information output by the temperature sensor. In other examples, the temperature may be sensed and monitored by measuring electrical characteristics of the system, e.g., the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article 10, respectively, remains within a predetermined temperature range. The characteristic may be, for example, amplitude or frequency or duty cycle. Within the predetermined temperature range, in use the aerosol generating material 11 within the article 10 located in the heating chamber 110 is heated sufficiently to volatilize at least one component of the aerosol generating material 11 without combusting the aerosol generating material 11. Accordingly, the controller 135, and the aerosol provision device 100 as a whole, is arranged to heat the aerosol generating material 11 to volatilize the at least one component of the aerosol generating material 11 without combusting the aerosol generating material 11. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

Further discussion of the form of each of the heating units 140a-140e will be given below with reference to FIGS. 2 and 3. However, what is notable at this stage is that the size or extent of the varying magnetic fields as measured in the direction of the axis A-A is relatively small, so that the portions of the susceptor 190 that are penetrated by the varying magnetic fields in use are correspondingly small.

Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosol generating material 11 that is heated by operation of each of the heating units 140a-140e. It has been found that it is desirable to provide the susceptor 190 with a thermal conductivity of at least 10 W/m/K, optionally at least 50 W/m/K, and further optionally at least 100 W/m/K. In this example, the susceptor 190 is made of aluminum and has a thermal conductivity of over 200 W/m/K, such as between 200 and 250 W/m/K, for example approximately 205 W/m/K or 237 W/m/K. As noted above, each of the portions 11a-11e of the aerosol generating material 11 may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

In this example, the heating apparatus 130 is configured to cause heating of the first portion 11a of the aerosol generating material 11 to a temperature sufficient to aerosolize a component of the first portion 11a of the aerosol generating material 11 before or more quickly than the heating of the second portion 11b of the aerosol generating material 11 during a heating session. More specifically, the controller 135 is configured to cause operation of the first and second heating units 140a,140b to cause the heating of the first portion 11a of the aerosol generating material 11 before or more quickly than the heating of the second portion 11b of the aerosol generating material 11 during the heating session. Accordingly, during the heating session, the position at which heat energy is applied to the aerosol generating material 11 of the article 10 is initially relatively fluidly spaced from the outlet 120 and the user, and then moves towards the outlet 120. This provides the benefit that during a heating session aerosol is generated from successive “fresh” portions of the aerosol generating material 11, which can lead to a sensorially-satisfying experience for the user that may be more similar to that had when smoking a traditional combustible factory-made cigarette.

Moreover, in some examples, the controller 135 is configured to cause a cessation in the supply of power to the first heating unit 140a, during at least part of a period (or all of the period) for which the controller 135 is configured to cause operation of the second heating unit 140b. This provides the further benefit that aerosol generated in a given portion of the aerosol generating material 11 need not pass through another portion of the aerosol generating material 11 that has previously been heated, which could otherwise negatively impact the aerosol.

In some examples in which the heating apparatus 130 has more than two heating units, such as the example shown in FIG. 1, during the heating session the heating apparatus 130 may also be configured to cause heating of at least one further portion 11b-11e of the aerosol generating material 11 to a temperature sufficient to aerosolize a component of the further portion 11b-11e of the aerosol generating material 11 before or more quickly than the heating of a still further portion 11c-11e of the aerosol generating material 11 that is fluidly closer to the outlet 120. That is, the controller 135 may be configured to cause suitable operation of the heating units to cause the heating of the at least one further portion 11b-11e of the aerosol generating material 11 before or more quickly than the heating of the still further portion 11c-11e of the aerosol generating material 11. For example, in the device of FIG. 1, the heating apparatus 130 may be configured to cause: (i) heating of the second portion 11b of the aerosol generating material 11 to a temperature sufficient to aerosolize a component of the second portion 11b of the aerosol generating material 11 before or more quickly than the heating of the third portion 11c of the aerosol generating material 11; (ii) heating of the third portion 11c of the aerosol generating material 11 to a temperature sufficient to aerosolize a component of the third portion 11c of the aerosol generating material 11 before or more quickly than the heating of the fourth portion 11d of the aerosol generating material 11; and (iii) heating of the fourth portion 11d of the aerosol generating material 11 to a temperature sufficient to aerosolize a component of the fourth portion 11d of the aerosol generating material 11 before or more quickly than the heating of the fifth portion 11e of the aerosol generating material 11.

It will be understood that, for a given duration of heating session, the greater the number of heating units and associated portions of the aerosol generating material 11 there are, the greater the opportunity to generate aerosol from “fresh” or unspent portions of the aerosol generating material 11 extending along a given axial length. Alternatively, for a given duration of heating each portion of the aerosol generating material 11, the greater the number of heating units and associated portions of the aerosol generating material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly. There may be a balance that is struck between the number of heating units (which may dictate the number of “fresh puffs”), the overall session length, and the achievable power supply (which may be dictated by the characteristics of the power source).

Referring to FIG. 2, there is shown a flow diagram showing an example of a method of heating aerosol generating material during a heating session using an aerosol provision device. The aerosol provision device used in the method 200 comprises a heating zone for receiving at least a portion of an article comprising aerosol generating material, an outlet through which aerosol is deliverable from the heating zone to a user in use, and heating apparatus for causing heating of the article when the article is at least partially located within the heating zone to thereby generate the aerosol. The aerosol provision device may, for example, be that which is shown in FIG. 1 or any of the suitable variants thereof discussed herein.

The method 200 comprises the heating apparatus 130 causing, when the article 10 is at least partially located within the heating zone 110, heating 210 of a first portion 12a of the aerosol generating material 11 of the article 10 to a temperature sufficient to aerosolize a component of the first portion 11a of the aerosol generating material 11 before or more quickly than heating 220 of a second portion 11b of the aerosol generating material 11 of the article 10 to a temperature sufficient to aerosolize a component of the second portion 11b of the aerosol generating material 11, wherein the second portion 11b of the aerosol generating material 11 is fluidly located between the first portion 11a of the aerosol generating material 11 and the outlet 120.

It will be understood from the teaching herein that the method 200 could be suitably adapted to comprise the heating apparatus 130 also causing heating of at least one further portion 11b-11e of the aerosol generating material 11 to a temperature sufficient to aerosolize a component of the further portion 11b-11e of the aerosol generating material 11 before or more quickly than the heating of a still further portion 11c-11e of the aerosol generating material 11 that is fluidly closer to the outlet 120, as discussed above.

Referring to FIG. 3, there is shown a flow diagram showing another example of a method of heating aerosol generating material during a heating session using an aerosol provision device. The aerosol provision device used in the method 300 comprises a heating zone for receiving at least a portion of an article comprising aerosol generating material, an outlet through which aerosol is deliverable from the heating zone to a user in use, and heating apparatus for causing heating of the article when the article is at least partially located within the heating zone to thereby generate the aerosol. The heating apparatus comprises a first heating unit, a second heating unit, a third heating unit and a controller that is configured to cause operation of the first, second and third heating units. The aerosol provision device may, for example, be that which is shown in FIG. 1 or any of the suitable variants thereof discussed herein.

The method 300 comprises the controller 135 controlling the first, second and third heating units 140a,140b,140c independently of each other to cause, when the article 10 is at least partially located within the heating zone 110: the first heating unit 140a to heat 310 a first portion 11a of the aerosol generating material 11 of the article 10 to a temperature sufficient to aerosolize a component of the first portion 11a of the aerosol generating material 11 (e.g. before or more quickly than the second portion 11b); the second heating unit 140b to heat 320 a second portion 11b of the aerosol generating material 11 of the article 10 to a temperature sufficient to aerosolize a component of the second portion 11b of the aerosol generating material 11 (e.g. before or more quickly than the third portion 11c); and the third heating unit 140c to heat 330 a third portion 11c of the aerosol generating material 11 of the article 10 to a temperature sufficient to aerosolize a component of the third portion 11c of the aerosol generating material 11, wherein the second portion 11b of the aerosol generating material 11 is fluidly located between the first portion 11a of the aerosol generating material 11 and the outlet 120, and the third portion 11c of the aerosol generating material 11 is fluidly located between the second portion 11b of the aerosol generating material 11 and the outlet 120.

When the aerosol provision device used in the method 300 comprises sufficient heating units, it will be understood from the teaching herein that the method 300 could be suitably adapted to comprise the heating apparatus 130 also controlling fourth and fifth heating units 140d, 140e independently of each other to cause, when the article 10 is at least partially located within the heating zone 110: the fourth heating unit 140d to heat a fourth portion 11d of the aerosol generating material 11 of the article 10 to a temperature sufficient to aerosolize a component of the fourth portion 11d of the aerosol generating material 11; and the fifth heating unit 140e to heat a fifth portion 11e of the aerosol generating material 11 of the article 10 to a temperature sufficient to aerosolize a component of the fifth portion 11e of the aerosol generating material 11, wherein the fourth portion 11d of the aerosol generating material 11 is fluidly located between the third portion 11c of the aerosol generating material 11 and the outlet 120, and the fifth portion 11e of the aerosol generating material 11 is fluidly located between the fourth portion 11d of the aerosol generating material 11 and the outlet 120.

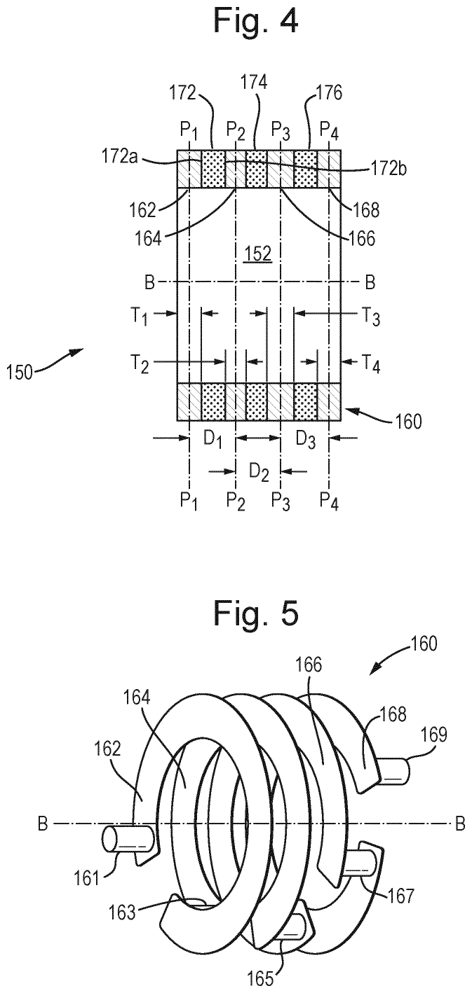

One of the heating units 140a-140e of the heating apparatus 130 will now be described in more detail with reference to FIGS. 4 and 5. These figures respectively show a schematic cross-sectional side view of an inductor arrangement 150 of the heating unit and a schematic perspective view of an inductor 160 of the inductor arrangement 150.

The inductor arrangement 150 comprises an electrically-insulating support 172 and the inductor 160. The support 172 has opposite first and second sides 172a, 172b, and parts 162, 164 of the inductor 160 are on the respective first and second sides 172a, 172b of the support 172.

More specifically, the inductor 160 comprises an electrically-conductive element 160. The element 160 comprises an electrically-conductive non-spiral first portion 162 that is coincident with a first plane Pi, and an electrically-conductive non-spiral second portion 164 that is coincident with a second plane P2 that is spaced from the first plane Pi. In this example, the second plane P2 is parallel to the first plane Pi, but in other examples this need not be the case. For example, the second plane P2 may be at an angle to the first plane P1, such as an angle of no more than 20 degrees or no more than 10 degrees or no more than 5 degrees. The inductor 160 also comprises a first electrically-conductive connector 163 that electrically connects the first portion 162 to the second portion 164. The first portion 162 is on the first side 172a of the support 172, and the second portion 164 is on the second side 172b of the support 172. The electrically conductive connector 163 passes through the support 172 from the first side 172a to the second side 172b.

The electrically conductive connector 163 may have the structure of plating (e.g. copper plating) on the surface of a through hole provided in the support 172.

The support 172 can be made of any suitable electrically-insulating material(s). In some examples, the support 172 comprises a matrix (such as an epoxy resin, optionally with added filler such as ceramics) and a reinforcement structure (such as a woven or non-woven material, such as glass fibers or paper).

The inductor 160 can be made of any suitable electrically-conductive material(s). In some examples, the inductor 160 is made of copper.

In some examples, the inductor arrangement 150 comprises, or is formed from, a PCB. In such examples, the support 172 is a non-electrically-conductive substrate of the PCB, which may be formed from materials such as FR-4 glass epoxy or cotton paper impregnated with phenolic resin, and the first and second portions 162, 164 of the inductor 160 are tracks on the substrate.

This facilitates manufacture of the inductor arrangement 150, and also enables the portions 162, 164 of the element 160 to be thin and closely spaced, as discussed in more detail below.

In this example, the first portion 162 is a first partial annulus 162 and the second portion 164 is a second partial annulus 164. Moreover, in this example, each of the first and second portions 162, 164 follows only part of a respective circular path. Therefore, the first portion or first partial annulus 162 is a first circular arc, and the second portion or second partial annulus 164 is a second circular arc. In other examples, the first and second portions 162, 164 may follow a path that is other than circular, such as elliptical, polygonal or irregular. However, matching the shape of the first and second portions 162, 164 to the shape (or at least an aspect of the shape, such as outer perimeter) of respective adjacent portions of the susceptor 190 (whether provided in the aerosol provision device 100 or the article 10) helps lead to improved and more consistent magnetic coupling of the inductor 160 and the susceptor 190. Moreover, in examples in which the first and second portions 162, 164 are respective circular arcs, providing that the radii of the circular arcs are equal also can help lead to the generation of a more consistent magnetic field along the length of the inductor 160, and thus more consistent heating of the susceptor 190.

The inductor arrangement 150 has a through-hole 152 that is radially-inward of, and coaxial with, the first and second portions 162,164 or partial annuli. In the assembled device 100, the susceptor 190 and the heating zone 110 extend through the through-hole 152, so that the portions 162,164 of the element 160 together at least partially encircle the susceptor 190 and the heating zone 110. In examples in which the susceptor 190 is replaced by plural susceptors, each of the plural susceptors may be located so as to extend through the through-holes 152 of one or more inductor arrangements 150 of the respective heating units 140a.-140e. In some examples, the or each susceptor does not extend through the through-holes 152, but rather is adjacent (e.g. axially) the associated element 160.

In examples in which the heating apparatus 130 is free from a susceptor, as discussed above, the heating zone 110 may still nevertheless extend through some or all of the through-holes 152 of the inductor arrangements 150 of the respective heating units 140a-140e. In some such examples, the article 10 comprises one or more susceptors, such as a metallic foil (e.g. aluminum foil) wrapped around or otherwise encircling the aerosol generating material 11 and/or a susceptor, such as in the form of a pad, at one end of the article 10 axially adjacent the aerosol generating material 11 of the article 10. In some examples, the susceptor of an article 10 comprising liquid or gel or otherwise flowable aerosol generating material may comprise a susceptor (e.g. metallic) in, or coated on, a (e.g. ceramic) wick. In some examples, portions 11a-11e of the aerosol generating material 11 have the same respective forms or characteristics, or have different respective forms or characteristics, such as different tobacco blends and/or different applied or inherent flavors. In some such examples, the article 10 may comprise plural susceptors, each of which is arranged and heatable to heat a respective one of the portions 11a-11e of the aerosol generating material 11. In some examples, the portions 11a-11e of the aerosol generating material 11 are isolated from each other. In other examples, there may be plural heating zones, each of which is located between a pair of the inductor arrangements 150.

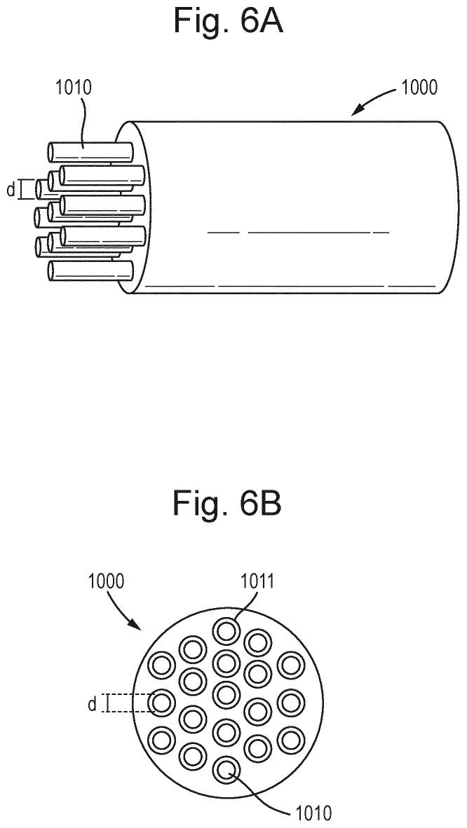

FIG. 6A shows a multi-strand wire 1000 according to an arrangement, where the individual strands 1010 are shown as exposed. FIG. 6B shows a multi-strand wire according to an arrangement in cross-section. Each strand of the multi-strand wire may be insulated from other strands by insulation 1011.

The diameter d of each individual strand 1010 may be less than a skin depth of the conductor at the frequency of the varying magnetic field f1.

In accordance with various embodiments the frequency of the varying magnetic field f1 is less than 500 kHz. As described previously, at these frequencies the skin depth of the conductor is increased, and therefore the individual strand diameter of the multi-strand wires of the induction coils can be made larger than at higher frequencies, and correspondingly the multi-strand wire can be made with fewer strands.

Such multi-strand wire may be simpler to manufacture and cheaper than multi-strand wire configured for higher frequency operation. Furthermore, the larger strand diameter may increase the robustness of the multi-strand wire, improving the durability of the inductor coil.

The improved durability and reduced cost may allow for the inductor coil to be included in the article comprising aerosol generating material rather than in the aerosol provision device. Accordingly, the induction coils may be provided in the article containing aerosol generating material. Additionally or alternatively, the induction coils may be provided in the aerosol provision device.

The aerosol provision device, aerosol generating system and the inductor coil according to various arrangements find particular utility when generating aerosol from a substantially flat article comprising aerosol generating material. The substantially flat article may be provided in either an array or a circular format. Other arrangements are also contemplated.

In some arrangements e.g. wherein the substantially flat article is provided in the form of an array, multiple heating regions may be provided. For example, according to an arrangement one heating region may be provided per portion, pixel or portion of the article.

In other arrangements, the substantially flat article may be rotated such that a segment of the article is heated by a similar shaped heater. According to this arrangement a single heating region may be provided.

The article may comprise a plurality of discrete portions of aerosol generating material.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof.

In some cases, the support itself be a laminate structure comprising layers of materials selected from the preceding lists. In some cases, the support may also function as a flavorant carrier. For example, the support may be impregnated with a flavorant or with tobacco extract.

In some cases, the support may be non-magnetic.

In some cases, the support may be magnetic. This functionality may be used to fasten the support to the assembly in use, or may be used to generate particular shapes of aerosol generating material. In some cases, the aerosol generating material may comprise one or more magnets which can be used to fasten the material to an induction heater in use.

In one particular case, the support may be a paper-backed foil. The paper layer may abut the aerosol generating material and the properties discussed in the previous paragraphs are afforded by this abutment. The foil backing is substantially impermeable, providing control of the aerosol flow path. A metal foil backing may also serve to conduct heat to the aerosol generating material.

In some cases, the support is formed from or comprises metal foil, such as aluminum foil. A metallic support may allow for better conduction of thermal energy to the aerosol generating material. Additionally, or alternatively, a metal foil may function as a susceptor in an induction heating system. In particular arrangements, the support comprises a metal foil layer and a support layer, such as cardboard. In these arrangements, the metal foil layer may have a thickness of less than 20 μm, such as from about 1 μm to about 10 μm, suitably about 5 μm. In some cases, the support may have a thickness of between about 0.010 mm and about 2.0 mm, suitably from about 0.015 mm, 0.02 mm, 0.05 mm or 0.1 mm to about 1.5 mm, 1.0 mm, or 0.5 mm.

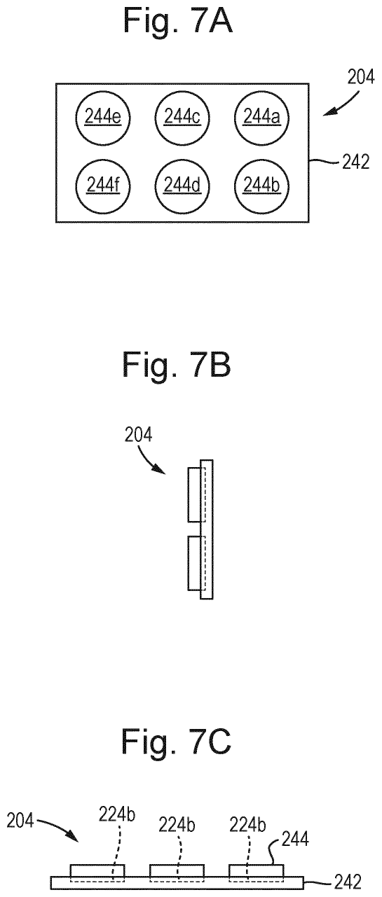

Reference is made to FIGS. 7A-7C. According to an arrangement an aerosol generating article 204 for use with an aerosol provision device may be provided wherein the aerosol generating article 204 comprises a planar aerosol generating article 204. The planar aerosol generating article 204 may comprise a carrier component 242, one or more susceptor elements 224b and one or more portions of aerosol generating material 244a-f as shown and described in more detail with reference to FIGS. 7A-7C.

FIG. 7A shows a top-down view of an aerosol generating article 204 according to an arrangement, FIG. 7B shows an end-on view along the longitudinal (length) axis of the aerosol generating article 204 according to an arrangement and FIG. 7C shows a side-on view along the width axis of the aerosol generating article 204 according to an arrangement.

The one or more susceptor elements 224b may be formed from aluminum foil, although it should be appreciated that other metallic and/or electrically conductive materials may be used in other implementations. As seen in FIG. 7C, the carrier component 242 may comprise a number of susceptor elements 224b which correspond in size and location to the discrete portions of aerosol generating material 244a-f disposed on the surface of the carrier component 242. That is, the susceptor elements 224b may have a similar width and length to the discrete portions of aerosol generating material 244a-f.

The susceptor elements 224b are shown embedded in the carrier component 242. However, in other arrangements, the susceptor elements 224b may be placed or located on the surface of the carrier component 242. According to another arrangement a susceptor may be provided as a single layer substantially covering the carrier component 244. According to an arrangement the aerosol generating article 204 may comprise a substrate or support layer, a single layer of aluminum foil which acts as a susceptor and one or more regions of aerosol generating material 244 deposited upon the aluminum foil susceptor layer.

According to an arrangement an array of induction heating coils may be provided to energize the discrete portions of aerosol generating material 244. However, according to other arrangements a single induction coil may be provided and the aerosol generating article 204 may be configured to move relative to the single induction coil. Accordingly, there may be fewer 10 induction coils than discrete portions of aerosol generating material 244 provided on the carrier component 242 of the aerosol generating article 204, such that relative movement of the aerosol generating article 204 and induction coil(s) is required in order to be able to individually energize each of the discrete portions of aerosol generating material 244.

Alternatively, a single induction coil may be provided and the aerosol generating article 204 may be rotated relative to the single induction coil.

Although the above has described implementations where discrete, spatially distinct portions of aerosol generating material 244 are deposited on a carrier component 242, it should be appreciated that in other implementations the aerosol generating material 244 may not be provided in discrete, spatially distinct portions but instead be provided as a continuous sheet, film or layer of aerosol generating material 244. In these implementations, certain regions of the sheet of aerosol generating material 244 may be selectively heated to generate aerosol in broadly the same manner as described above. In particular, a region (corresponding to a portion of aerosol generating material) may be defined on the continuous sheet of aerosol generating material 244 based on the dimensions of the one or more inductive heating elements.

According to various arrangements the aerosol generating article 204 may comprise a disc shaped or circular article.

In order to address various issues and advance the art, the entirety of this disclosure shows by way of illustration and example various embodiments in which that which is claimed may be practiced and which provide for superior inductors, superior inductor arrangements, superior inductor assemblies, superior magnetic field generators, superior aerosol provision devices, and superior aerosol provision systems. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An aerosol provision device comprising:
an aerosol generator comprising one or more heating zones for receiving at least a portion of an article comprising aerosol generating material;
a magnetic field generator configured to generate a time varying magnetic field; and
an AC voltage supply configured to supply an AC voltage to the magnetic field generator at a frequency f1, wherein f1<500 kHz.

2. The aerosol provision device as claimed in claim 1, wherein the magnetic field generator comprises one or more inductor coils.

3. The aerosol provision device as claimed in claim 2, wherein the one or more inductor coils comprise one or more multi-strand wires.

4. The aerosol provision device as claimed in claim 3, wherein the one or more multi-strand wires comprise a plurality of strands, wherein each of the plurality of strands has a thickness less than a skin depth of a strand at frequency f1.

5. The aerosol provision device as claimed in claim 1, further comprising one or more susceptors.

6. The aerosol provision device as claimed in claim 5, wherein the magnetic field generator is configured to induce heating in the one or more susceptors.

7. The aerosol provision device as claimed in claim 5, wherein the one or more susceptors comprise: nickel; steel; a body having a nickel coating; a sheet of mild steel; or an aluminum foil.

8. The aerosol provision device as claimed in claim 1, wherein the frequency f1 is selected from the group consisting of: <kHz; 50-100 kHz; 100-150 kHz; 150-200 kHz; 200-250 kHz; 250-300 kHz; 300-350 kHz; 350-400 kHz; 400-450 kHz; and 450-500 kHz.

9. An aerosol provision system comprising:
the aerosol provision device as claimed in claim 1; and
the article comprising the aerosol generating material.

10. The aerosol provision system as claimed in claim 9, wherein the article further comprises one or more susceptors.

11. The aerosol provision system as claimed in claim 9, wherein the one or more susceptors comprise: nickel; steel; a body having a nickel coating; a sheet of mild steel; or an aluminum foil.

12. The aerosol provision system as claimed in claim 9, wherein the article further comprises one or more inductor coils.

13. The aerosol provision system as claimed in claim 12, wherein the one or more inductor coils comprise one or more multi-strand wires.

14. The aerosol provision system as claimed in claim 13, wherein the one or more multi-strand wires comprise a plurality of strands, wherein each of the plurality of strands has a thickness less than a skin depth of a strand at frequency f1.

15-23. (canceled)

24. A method of generating an aerosol comprising:
providing one or more heating zones for receiving at least a portion of an article comprising aerosol generating material;
generating a time varying magnetic field using a magnetic field generator; and
supplying an AC voltage to the magnetic field generator at a frequency f1, wherein f1<500 kHz.
